(19) United States
(12) Patent Application Publication
(10) Pub. No.: US 2012/0257766 A1
(43) Pub. Date: Oct. 11, 2012

(54) APPARATUS AND METHOD FOR MEDIA PRESENTATION

(75) Inventors: Shafer Seymour, Bartlett, IL (US); Robert Gee, Lake Barrington, IL (US)

(73) Assignee: CONTINENTAL AUTOMOTIVE SYSTEMS, INC., Deer Park, IL (US)

(21) Appl. No.: 13/080,325

(22) Filed: Apr. 5, 2011

(51) Int. Cl. H04B 1/00

(52) U.S. Cl. 381/86

(57) ABSTRACT

A user who desires to use a media application at a vehicle is identified. A stop mark associated with the user is created and the stop mark is configured to uniquely identify the user compared to other users. The media application is presented to the user at the vehicle. The operation of the media application is halted at a stopping point when the user is using the media application and according to instructions from the user. The stopping point on the media is marked with the stop mark. Subsequently, the media application is restarted according to the stop mark when the user wishes to restart the media application.

### FIELD OF THE INVENTION

The invention relates generally to media presentation devices, and, more specifically to controlling and operating these devices.

### BACKGROUND OF THE INVENTION

Vehicles are now equipped with hard drives and other media storage/presentation devices that are capable of holding many hours of programming. For example, drivers and their passengers in vehicles may listen to music or audio books as they drive. Other examples of programming and media types are possible.

Multiple users typically use these media presentation devices. For instance, a vehicle may be operated by both a husband and wife. Multiple occupants of the vehicle may wish, for example, listen to the same audio book at different times. However and in almost all cases, the amount of programming listened to or received by users is not the same. For instance, one user may listen to more of the same book than another user. In the case of music, multiple users may listen to totally different songs or may leave off at different places within a particular compact disc.

Often, the user wishes to cease listening and then resume listening later. For example, the user may drive to work and then leave their vehicle to return later in the day when their work day is completed. In another example, a driver may drive to complete various errands and thus may be constantly stopping the audio presentation only to restart the presentation later.

Unfortunately, previous systems offer no mechanism where, in a multiple user environment, each user can halt the presentation of the media only to return later and have the presentation resumed at the correct place for each listener. In fact, each user has to remember various pieces of complicated information, for example, the disk, track, and potentially the time offset into a track. The last of these items must be remembered in the case where audio tracks are quite long. Because of these problems, user frustration with current systems exists.

### BRIEF DESCRIPTION OF THE DRAWINGS

The present invention is illustrated, by way of example and not limitation, in the accompanying figures, in which like reference numerals indicate similar elements, and in which:

FIG. 1 comprises an apparatus for controlling media presentation according to various embodiments of the present invention;

FIG. 2 comprises a flowchart showing one approach for controlling media presentation according to various embodiments of the present invention;

FIG. 3 comprises a flowchart showing an approach for controlling media presentation according to various embodiments of the present invention;

FIG. 4 comprises a diagram showing one example of stop marks according to various embodiments of the present invention;

FIG. 5 comprises a diagram of a system for controlling media presentation as disposed in the interior of a vehicle according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

In the approaches described herein, the media presentation at a vehicle or some other location is controlled such that a media presentation can be halted and marked with a stop mark that uniquely identifies particular users. When a particular user wishes to resume the media presentation, the appropriate stop mark is used to find the place in the application where the restart is to occur and the media presentation is resumed according to that mark. Different criteria (e.g., user-based criteria) can also be used to control the presentation and resumption of the presentation of the media application. Thus, using the approaches described herein multiple users do not have to remember where the presentation was halted and the media is automatically restarted according to identity of each user.

In some of the examples described herein, two users are described and each may be assigned a stop mark. However, it will be appreciated that the approaches described herein are applicable to any number of users. Also, it will be appreciated that many of the examples described herein are described in connection with a vehicular environment. However, it will be appreciated that the approaches described herein can be implemented in any type of environment.

As described herein, “marking” media with a stop mark means associating a stop mark with media (e.g., a hard drive). More specifically, the stop mark identifies a point or area on physical media (or a logical representation thereof) where a presentation (e.g., an audio book, music, video player, audio presentation) was stopped and is to be resumed. The stop mark itself may not be incorporated into the same physical media (although in some cases it may be). Rather, the stop mark may be stored elsewhere (e.g., in another separate computer memory) and will point to the resumption point on the actual media (e.g., using an address or pointer).

In many of these embodiments, a user who desires to use a media application at a vehicle is identified. A stop mark associated with the user is created and the stop mark is configured to uniquely identify the user compared to other users. The media application is presented to the user at the vehicle. The operation of the media application is halted at a stopping point when the user is using the media application and according to instructions from the user. The stopping point on the media is marked with the stop mark. Subsequently, the media application is restarted according to the stop mark when the user wishes to restart the media application.

In some aspects, the application is re-started at a time that is based at least in part upon a type of the media application, the time being an offset time relative to the stop mark. In other aspects, the application is re-started at a predetermined time period as measured from the stop mark.

The media application may be any number of media applications. For example, the media application may be a book, music (e.g., on a CD ROM or disc or any other media), a video presentation, or an audio presentation, and combinations thereof. Other examples are possible. As used herein, “media application” or “media presentation” refers to any combination of audio and/or visual applications or presentations from or stored on any type of media (e.g., a hard drive, magnetic tape, a random access memory, a computer CD ROM, and so forth).

In still other aspects, the identity of the user may be established by a variety of different ways such as identifying a key used to activate or access the vehicle, identifying a fob used to activate or access the vehicle, indentifying a voice of the user, identifying an action at user interface, or identifying the user according to a biometric approach. Other identification approaches may also be used.

In others of these embodiments, a first user of a vehicle that desires to use a media application is identified and a first stop mark associated with the first user is created. The first stop mark is configured to uniquely identify the first user. A second user that desires to use the media application is identified and a second stop mark associated with the second user is created. The second stop mark is configured to uniquely identify the second user.

A media application is utilized by the first user or the second user at the vehicle and subsequently the operation of the media application is halted at a stopping point. It is determined whether the first user or the second user is using the media application. The stopping point is marked with the first stop mark when the first user is utilizing the media application and the stopping point is marked with the second stop mark when the second user is utilizing the media application.

In other aspects, an instruction to restart the application is received and it is identified whether the instruction is from the first user or the second user. Subsequently, the media application is re-started according to the first stop mark when the instruction is from the first user. The media application is restarted according to the second stop mark when the instruction is from the second user.

In still other aspects, the application is re-started at a time that is based at least in part upon a type of the media application, the time being an offset time relative to the stop mark. In yet other aspects, the application is re-started at a predetermined time period as measured from the stop mark.

The media application may be any number of applications. For example, the media application may be a book, music (e.g., on a CD ROM or disc or any other media), a video presentation, or an audio presentation, and combinations thereof. Other examples are possible.

In still other aspects, the identity of the user may be established by a variety of different ways such as identifying a key used to activate or access the vehicle, identifying a fob used to activate or access the vehicle, indentifying a voice of the user, identifying an action at user interface, or identifying the user according to a biometric approach. Other identification approaches may also be used.

In others of these embodiments, an apparatus for controlling the presentation of media in a vehicle includes an interface and a controller. The interface has an input and an output. The input is configured to receive a communication from a user who desires to use a media application at a vehicle.

The controller is coupled to the interface and is configured to determine an identity of the user based upon the communication, create a stop mark associated with the user. The stop mark is configured to uniquely identify the user compared to other users. The controller is further configured to transmit a first signal at the output to the media application halting operation of the application at a stopping point upon reception of a first instruction received at the input indicating the user wishes to halt the application. The controller is still further configured to configure the stop mark to mark the stopping point in the application.

In other aspects, the controller is further configured to subsequently, transmit a second signal at the output to restart the media application according to the stop mark upon receipt of a second instruction at the input indicating that the user wishes to restart the media application.

In other aspects, the controller is configured to restart the application at a time that is based at least in part upon a type of the media application. In some other aspects, the controller is configured to restart the application at a predetermined time period as measured from the stop mark.

The media application may be any number of applications. For example, the media application may be a book, music (e.g., on a CD ROM or disc or any other media), a video presentation, or an audio presentation, and combinations thereof. Other examples are possible.

In still other aspects, the identity of the user may be established by a variety of different ways such as identifying a key used to activate or access the vehicle, identifying a fob used to activate or access the vehicle, indentifying a voice of the user, identifying an action at user interface, or identifying the user according to a biometric approach. Other identification approaches may also be used.

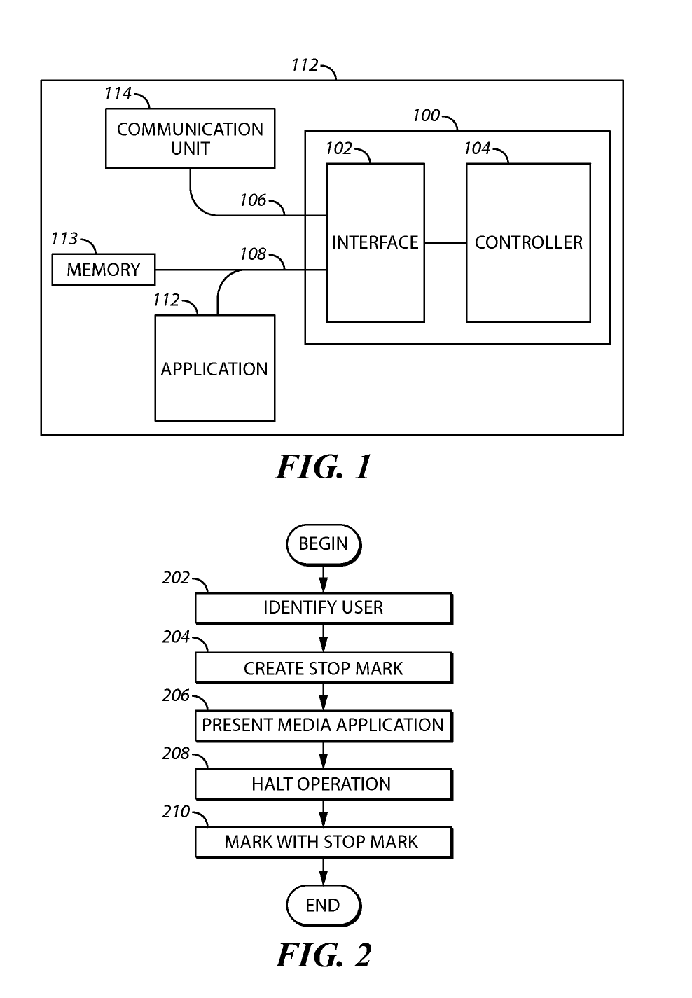

Referring now to FIG. 1, one example of an apparatus 100 for controlling the presentation of media includes an interface 102 and a controller 104. The interface 102 has an input 106 and an output 108. The input 106 is configured to receive a communication from a user who desires to use a media application at a vehicle. The communication may be received from a communication unit 114. The communication unit 114 may be a microphone, keyboard, touch screen, or any other type of hardware or software combination that is used to receive information or actions that indicate the identity of a user. In other example, the communication unit 114 accepts a user key or reads a fob. In this case, the information from such a reading is conveyed from the communication unit 114 to the apparatus 100. The input 106 may be coupled to the communication unit 114 by any type of communication link such as a wired communication link or a wireless communication link.

The controller 104 is coupled to the interface 102 and is configured to determine an identity of the user based upon the information received from the unit 104, create a stop mark associated with the user. The stop mark configured to uniquely identify the user compared to other users. The stop mark may be stored at a memory at the controller 104, another memory 113, or the application 112.

The controller 104 is further configured to transmit a first signal at the output 108 to a media application 112. This first signal is received at the media application 112 and halts presentation of the media via the application 112 at a stopping point. The first signal is formed upon reception of a first instruction at the input 106 indicating that the user wishes to halt presentation of the media at the application 112. The controller 104 is still further configured to transmit the stop mark to the application 112 at the output 108 in order to mark the stopping point at the application 112. Alternatively, the stop mark is not transmitted and is configured to indicate where the stopping point occurred.

In other aspects, the controller 104 is configured to subsequently, transmit a second signal at the output 108 that is effective to restart the media application 112 according to the stop mark upon receipt of a second instruction at the input indicating that the user wishes to restart the media application 112.

In other aspects, the controller 104 is configured to restart the application 112 at a time that is based at least in part upon a type of the media application, the time being an offset time relative to the stop mark. In some other aspects, the controller 104 is configured to restart the application 112 at a predetermined time period as measured from the stop mark.

The media application 112 may be any number of applications. For example, the media application may be a book, music (e.g., on a CD ROM or disc or any other media), a video presentation, or an audio presentation, and combinations thereof. Other examples are possible.

In still other aspects, the identity of the user may be established by a variety of different ways such having the controller 104 identify a key used to activate or access the vehicle, having the controller 104 identify a fob used to activate or access the vehicle, having the controller 104 indentify a voice of the user, having the controller 104 identify an action at user interface, or having the controller 104 identify the user according to a biometric approach. Other identification approaches may also be used. In these situations, the communication device 114 may obtain information (e.g., information related to a vehicle key obtained by the device 114, information obtained from the fob by the device 114, voice signal information when the device 114 is a microphone, biometric information, for instance when the device 114 is a fingerprint scanner, or actions of the user (e.g., a user movement)). The controller 104 then evaluates the information. Alternatively, the device 114 may itself directly determine the identity of the user and communicate the identity to the controller 104.

In one example of the operation of the system of FIG. 1, audio preference information and stop marks are saved for each user. The user is identified. For example, the user may place a key in the vehicle to activate it and the key has unique identification information associated with it. The communication unit 114 may receive the key or the communication unit 114 may obtain the information from the key and communicate this information to the apparatus 100. A stop mark may be created and applied to the application 112. The user may stop the application 112 (e.g., leave their vehicle) and then return to the vehicle inserting their key and thus identifying themselves again. When resuming the program 112 (e.g., a book, playlist, album, and so forth) if a stop mark is available for the current user, it is used to determine the restart point.

In other examples, if voice recognition (VR) is available, the system can add speaker recognition, in addition to speech recognition, for instance, to the communication unit 114 and/or controller 104. For instance, if a first user and a second user have been independently listening to the same book, there will be two different stop marks, one for each user. Using speaker recognition, the first user is driving, and therefore the primary user in the vehicle, the second user can press a “listen-to-me” button and say “resume book Atlas Shrugged”. The unit 114 will recognize who is speaking and select the proper resume point (i.e., proper stop mark). If only one stop mark exists, that mark will be used. If the first user has a stop mark, and the second user wants to begin the same book, the second user would say “begin book Atlas Shrugged” and a new stop mark will be created and tagged to the second user.

Music presentation can be accomplished in a similar way. “Play Ummagumma” or “resume Point of Know Return” may be spoken by a user. If a stop mark exists for the speaker, that stop mark will be used for resumption purposes; if none exists for that speaker, but one or more stop mark points do exist for the song, album, or playlist, one can be selected according to user specified criteria—oldest, newest, or some other criteria. Further, a command (voice or via tactile user interface such as a keyboard or buttons) may be implemented that allows a specific user to be selected and all commands, no matter who speaks them, will assume that user for the purpose of selecting a resume point (stop mark to use).

In another example of the operation of the system of FIG. 1, when audio files at application 112 have stop marks or tags that indicate a category of content (e.g., ID3-compliant), behavior can be altered based on the content type. To take one example, during presentation of an audio book, if the book is paused and resumed within a predetermined time (e.g., an hour or less) the audio will pick up where it was paused. It will be appreciated that all behaviors, including interval times, can be customized by the user.

If the interval is in a second time period (e.g., between one and 24 hours), the audio will be resumed two minutes prior to the pause point. If the interval is more than another time period (e.g., 24 hours), the audio will be resumed five minutes prior to the pause point.

In the case where music is presented, if paused and resumed within a predetermined time (e.g., an hour or less) the audio will pick up where it was paused. If the interval is in another time period (e.g., between one and 24 hours), the audio will be resumed at the beginning of the current track. It will be appreciated that the above-described operations, values, and ranges are examples only and that numerous examples can be used depending upon the needs of the users or the system.

Referring now to FIG. 2, one approach for controlling presentation of media at a vehicle is described. At step 202, a user who desires to use a media application at a vehicle is identified. At step 204, a stop mark associated with the user is created and the stop mark is configured to uniquely identify the user compared to other users. It will be understood that the approaches described herein can be utilized with any number of users. Additionally, although the approaches are used within a vehicle it will be appreciated that the approaches may be used at any location.

At step 206, the media application is presented to the user at the vehicle. For example, both audio and visual presentation elements may be used. For example, if the media is a book, it may be read out loud.

At step 208, the operation of the media application is halted at a stopping point when the user is using the media application and according to instructions from the user.

At step 210, the stopping point at the media is marked with the stop mark. Subsequently, the media application is restarted according to the stop mark when the user wishes to restart the media application.

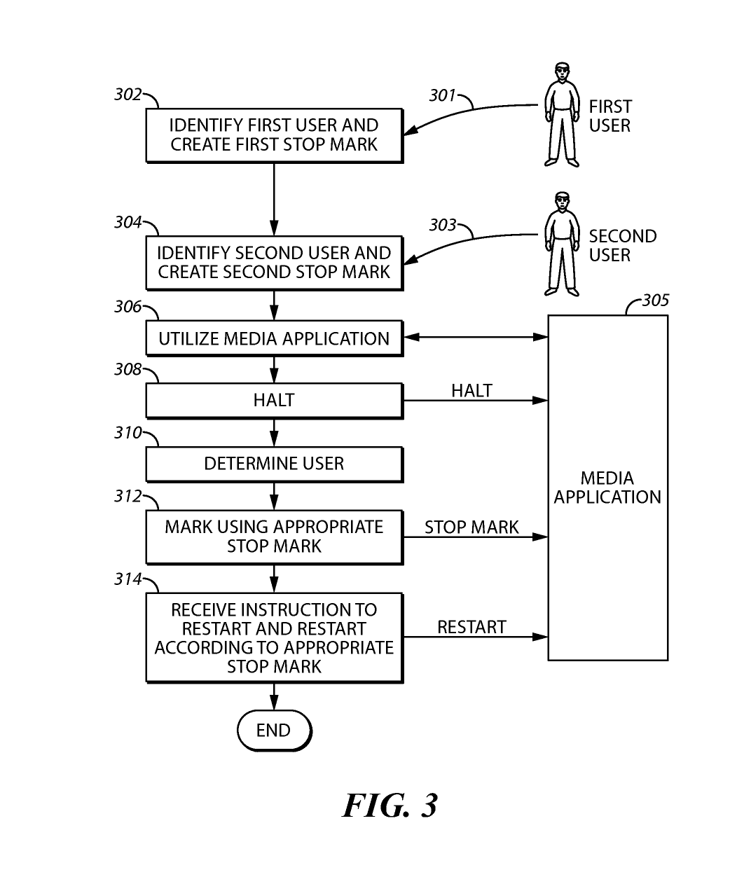

Referring now to FIG. 3, an approach for controlling presentation of media at a vehicle is described. At step 302, a first user of a vehicle that desires to use a media application 305 is identified and a first stop mark associated with the first user is created. The first stop mark is configured to uniquely identify the first user. This may be accomplished by receiving first input communications 301 from the first user.

At step 304, a second user that desires to use the media application 305 is identified and a second stop mark associated with the second user is created. The second stop mark is configured to uniquely identify the second user. This may be accomplished by receiving second input communications 303 from the second user.

At step 306, a media application is utilized by the first user or the second user at the vehicle and subsequently at step 308 the operation of the media application 305 is halted at a stopping point. At step 310, it is determined whether the first user or the second user is using the media application 305. At step 312, the stopping point is marked with the first stop mark when the first user is utilizing the media application 305 and the stopping point is marked with the second stop mark when the second user is utilizing the media application 305.

At step 314, an instruction to restart the application is received and it is identified whether the instruction is from the first user or the second user. Subsequently, at step 314, the media application 305 is re-started according to the first stop mark when the instruction is from the first user. The media application 305 is restarted according to the second stop mark when the instruction is from the second user.

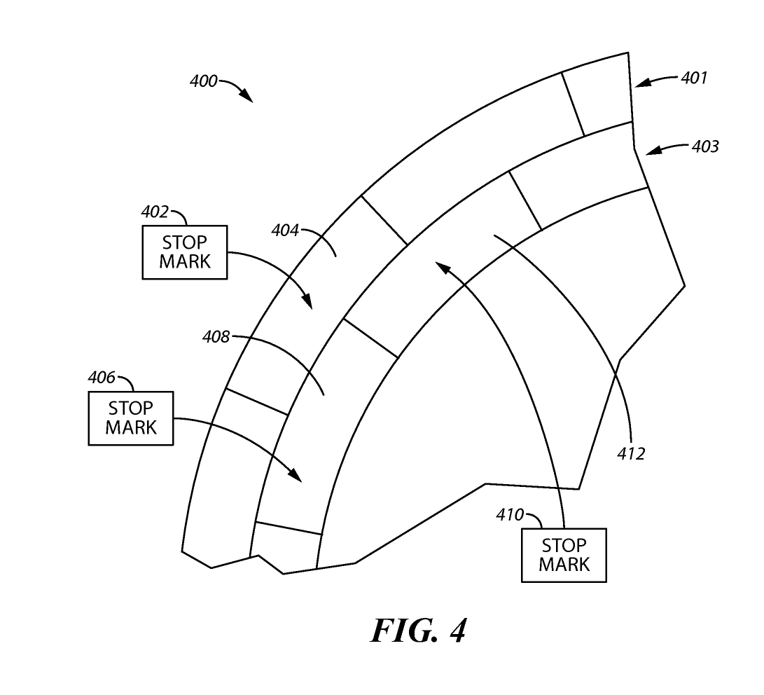

Referring now to FIG. 4, one example of stop marks is described. A media application 400 (e.g., recorded music) stored on a hard drive is divided into sectors and tracks. A first stop mark 402 points to a first track 401, first sector 404. A second stop mark 406 points to a second track 403, second sector 408. A third stop mark 410 points to the second track 403 and a third sector 412. It will be appreciated that the marks 402, 406, and 410 may themselves be stored in a memory that stores the instructions that executes the application 400 or at some other suitable location. The marks 402, 406, and 410 may be implemented according to any appropriate data structure such as a pointer. In this respect, each of the stop marks may include a field that uniquely identifies a user (e.g., with a unique user identifier).

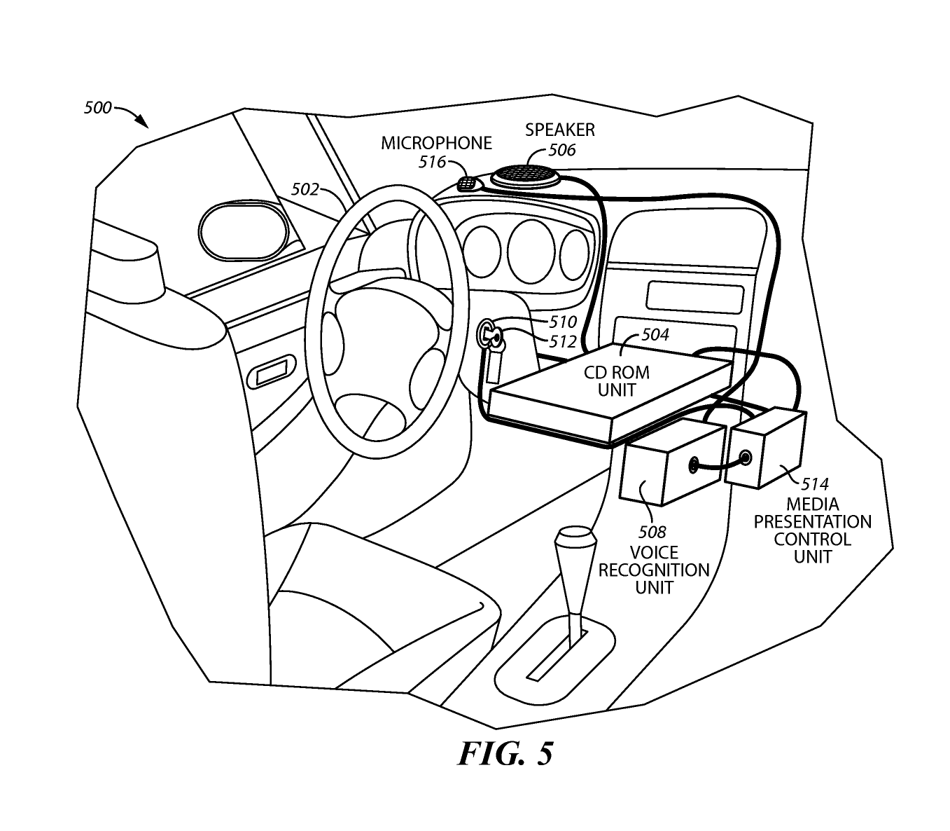

Referring now to FIG. 5, one specific example of implementing these approaches in a vehicle is described. An interior of a vehicle 500 (including a steering wheel 502) includes a CD unit 504 that is configured to play CDs (music or books) or is otherwise a computer hard drive that has recorded media disposed thereon. The unit 504 is coupled to a speaker 506 so that a user can hear the presentation of the media from the unit 504 (e.g., the playing of music). A voice recognition unit 508 and an ignition 510 (for receiving a key 512) are coupled to a media presentation control unit 514. The media presentation control unit 514 is coupled to the CD ROM unit 504 and controls the operation of that unit by creating and placing or associating stop marks at the unit 504. The media presentation control unit 514 may operate as described above with respect to the apparatus 100 of FIG. 1.

The voice recognition unit 508 is configured to analyze whether speech is present, the content of the speech, and/or recognize the identity of various speakers. These functions and the implementation of these functions are well known to those skilled in the art and will not be discussed further here.

In one example of the operation of the system of FIG. 5, a user may identify themselves by inserting the key 512 into the ignition 510. The key may include information that identifies the user and this information may be sent to the unit 514. In addition or alternatively, a user may speak into a microphone 516 to identify themselves. A media application (e.g., a book) may be stored at the CD ROM unit 504 and presentation of the media application may be started by having the user say “start” in which case the voice recognition unit 508 may recognize the command and start presentation of the application (e.g., the book) via the speaker 506. The unit 508 may also recognize the identity of the user and communicate that to the unit 514 which starts the unit. Alternatively, buttons or other controls on the unit 504 may be used to start the presentation of the application.

After the user is identified, a stop mark may be created and that stop mark uniquely identifies the user. For example, a random number may be generated that uniquely identifies the user. The stop mark will be utilized when the user is engaged in a media presentation (e.g., listening to audio) and the presentation is halted.

While listening, a user may stop or halt the media presentation. The stop mark may be sent from the unit 514 to the CD ROM unit 504 to mark the place where the unit is stopped. The stop mark may also be stored by the media presentation control unit 514, based on position or time information received from the CD ROM unit 504. When the user wishes to resume, the user is again identified (having them speak a command into microphone 516 to the voice recognition unit 508 which recognizes the voice or by inserting the key in the ignition system 510 or by any other approach). Then, the presentation may be resumed.

To take another example, if a first user and a second user have been independently listening to the same book, there will be two different stop marks, one for each user. Using speaker recognition, the first user is driving, and therefore the primary user in the vehicle, the second user can press a “listen-to-me” button and say “resume book Atlas Shrugged”. The unit 508 will recognize who is speaking and select the proper resume point. If only one stop mark exists, that one will be used. If the first user has a stop mark, and the second user wants to begin the same book, the second user would say “begin book Atlas Shrugged” and a new stop mark will be created and tagged to the second user.

Music presentation is accomplished in a similar way in the system of FIG. 5. “Play Ummagumma” or “resume Point of Know Return” may be spoken by a user. If a stop mark exists for the speaker, that stop mark will be used for resumption purposes; if none exists for that speaker, but one or more stop mark points do exist for the song, album, or playlist, one will be selected according to user specified criteria—oldest, newest, or some other criteria. Further, a command (e.g., a voice command recognized at the voice recognition unit 508) may be implemented that allows a specific user to be selected and all commands, no matter who speaks them, will assume that user for the purpose of selecting a resume point (stop mark to use).

In another example of the operation of the system of FIG. 5, when audio files stored at the CD ROM unit 504 have stop marks or tags that indicate a category of content (e.g., ID3-compliant), behavior can be altered based on the content type. To take one example, during presentation of an audio book, if the book is paused and resumed within a predetermined time (e.g., an hour or less) the audio will pick up where it was paused. It will be appreciated that all behaviors, including interval times, can be customized by the user.

If the interval is in a second time period (e.g., between one and 24 hours), the audio will be resumed two minutes prior to the pause point. If the interval is more than another time period (e.g., 24 hours or less), the audio will be resumed five minutes prior to the pause point.

In the case where music is presented, if paused and resumed within a predetermined time (e.g., less than an hour) the audio will pick up where it was paused. If the interval is in another time interval (e.g., between one and 24 hours), the audio will be resumed at the beginning of the current track. It will be appreciated that the above-described operations are examples only and that numerous examples can be used depending upon the needs of the users or the system.

It will be understood that the functions described herein may be implemented by computer instructions stored on a computer media (e.g., in a memory) and executed by a processing device (e.g., a microprocessor, controller, or the like).

It is understood that the implementation of other variations and modifications of the present invention and its various aspects will be apparent to those of ordinary skill in the art and that the present invention is not limited by the specific embodiments described. It is therefore contemplated to cover by the present invention any modifications, variations or equivalents that fall within the spirit and scope of the basic underlying principles disclosed and claimed herein.

What is claimed is:

1. A method of controlling the presentation of media at a vehicle, the method comprising:
identifying a user who desires to use a media application at a vehicle;
creating a stop mark associated with the user, the stop mark configured to uniquely identify the user compared to other users;
presenting the media application to the user at the vehicle;
halting the operation of the media application at a stopping point when the user is using the media application and according to instructions from the user;
marking the stopping point on the media with the stop mark;
subsequently, restarting the media application according to the stop mark when the user wishes to restart the media application.

2. The method of claim 1 wherein restarting according to the stop mark comprises restarting the application at a time that is based at least in part upon a type of the media application, the time being an offset time relative to the stop mark.

3. The method of claim 1 wherein restarting according to the stop mark comprises restarting the application at a predetermined time period as measured from the stop mark.

4. The method of claim 1 wherein the media application is selected from the group consisting of a book, music, a video presentation, and an audio presentation.

5. The method of claim 1 wherein determining an identity of a user comprises determining an identity according to an approach selected from the group consisting of:
identifying a key used to activate or access the vehicle, identifying a fob used to activate or access the vehicle, indentifying a voice of the user; identifying an action at user interface, and identifying the user according to a biometric approach.

6. A method of controlling the presentation of media at a vehicle, the method comprising:
identifying a first user of a vehicle that desires to use a media application and creating a first stop mark associated with the first user, the first stop mark configured to uniquely identify the first user;
identifying a second user that desires to use the media application and creating a second stop mark associated with the second user, the second stop mark being configured to uniquely identify the second user;
utilizing a media application by the first user or the second user at the vehicle and subsequently halting the operation of the media application at a stopping point;
determining whether the first user or the second user is using the media application;
marking the stopping point with the first stop mark when the first user is utilizing the media application and marking the stopping point with the second stop mark when the second user is utilizing the media application.

7. The method of claim 6 further comprising:
receiving an instruction to restart the application and identifying whether the instruction is from the first user or the second user;
subsequently, restarting the media application according to the first stop mark when the instruction is from the first user and restarting the media application according to the second stop mark when the instruction is from the second user.

8. The method of claim 7 wherein restarting according to the first stop mark or the second stop mark comprises restarting the application at a time that is based at least in part upon a type of the media application, the time being an offset time relative to the stop mark.

9. The method of claim 7 wherein restarting according to the first stop mark or the second stop mark comprises restarting the application at a predetermined time period as measured from the stop mark.

10. The method of claim 6 wherein the media application is selected from the group consisting of a book, music, a video presentation, and an audio presentation.

11. The method of claim 6 wherein identifying a first user or a second user comprises determining an identity according to an approach selected from the group consisting of: identifying a key used to activate or access the vehicle, identifying a fob used to activate or access the vehicle, indentifying a voice of the user; identifying an action at user interface, and identifying the user according to a biometric approach.

12. An apparatus for controlling the presentation of media in a vehicle, the apparatus comprising:
an interface having an input and an output, the input configured to receive a communication from a user who desires to use a media application at a vehicle;
a controller coupled to the interface, the controller configured to determine an identity of the user based upon the communication, create a stop mark associated with the user, the stop mark configured to uniquely identify the user compared to other users, the controller further configured to transmit a first signal at the output to the media application halting operation of the application at a stopping point upon reception of a first instruction received at the input indicating the user wishes to halt the application, the controller being still further configured to configure the stop mark to mark the stopping point in the application.

13. The apparatus of claim 12 wherein the controller is further configured to subsequently, transmit a second signal at the output to restart the media application according to the stop mark upon receipt of a second instruction at the input indicating that the user wishes to restart the media application.

14. The apparatus of claim 13 wherein the controller is configured to restart the application at a time that is based at least in part upon a type of the media application.

15. The apparatus of claim 13 wherein the controller is configured to restart the application at a predetermined time period as measured from the stop mark.

16. The apparatus of claim 12 wherein the media application is selected from the group consisting of a book, music, a video presentation, and an audio presentation.

17. The apparatus of claim 12 wherein the controller determines an identity of a user according to an approach selected from the group consisting of: identifying a key used to activate or access the vehicle, identifying a fob used to activate or access the vehicle, indentifying a voice of the user; identifying an action at user interface, and identifying the user according to a biometric approach.
